(19) United States
(12) Patent Application Publication
(10) Pub. No.: US 2023/0373591 A1
(43) Pub. Date: Nov. 23, 2023

(54) FRAME ASSEMBLY

(71) Applicant: Robert Bosch GmbH, Stuttgart (DE)

(72) Inventors: Daniel Schwenk, Dornstetten (DE); Julian Binder, Wannweil (DE); Christoph Schumacher, Dusslingen (DE); Peter Kimmich, Steinenbronn (DE); Sigmund Braun, Kusterdingen (DE)

(21) Appl. No.: 18/044,711

(22) PCT Filed: Nov. 5, 2021
(86) PCT No.: PCT/EP2021/080730

§ 371 Date: Mar. 9, 2023

(30) Foreign Application Priority Data
Dec. 7, 2020 (DE) 10 2020 215 407.4

(51) Int. Cl. B62M 6/55; B62K 25/28; B62K 3/02

(52) U.S. Cl. CPC B62M 6/55; B62K 25/286; B62K 3/02

(57) ABSTRACT

A frame assembly of a two-wheeled vehicle, operable with muscle power and/or motor power. The frame assembly includes a main frame, a sprung rear triangle, and at least one connecting element, which is arranged on the main frame. The connecting element connecting at least a part of the rear triangle to the main frame so as to be pivotable about a joint axis, and the connecting element being equipped for mounting a drive unit on the main frame.

### FIELD

The present invention concerns a frame assembly and a two-wheeled vehicle comprising the frame assembly.

### BACKGROUND INFORMATION

Two-wheeled vehicles, such as electric bicycles, having a full suspension system are described in the related art. The bicycle frame in this case comprises a main frame and a sprung rear triangle. The rear triangle is conventionally rotatable relative to the main frame at a main pivot point. In the case of electric bicycles, a drive unit is located in the vicinity of the bottom bracket axis, said drive unit requiring additional space and being connected to the main frame. The space requirement of the drive arrangement and the position of the main pivot point are often in conflict with one another.

### SUMMARY

A frame assembly according to the present invention allows for a simplified design and improved kinematics of a two-wheeled vehicle frame with suspension. This may be achieved in accordance with an example embodiment of the present invention by a frame assembly comprising a main frame, a sprung rear triangle, and at least one connecting element. The connecting element is arranged on the main frame. The connecting element connects at least a part of the rear triangle to the main frame so as to be pivotable about a joint axis. Moreover, the connecting element is equipped for mounting a drive unit on the main frame, particularly on the joint axis.

In other words, the frame assembly has in the connecting element an interface which permits the pivotable connection of at least part of the rear triangle to the main frame and at the same time the mounting of a drive unit on the main frame. The connecting element thus fulfils the two functions of pivotable connection and mounting interface, at the same time and in the same place, specifically on the joint axis. The connecting element thus constitutes both a pivot point and a mounting point. The connecting element may preferably be regarded as a joint which, in addition to pivotably connecting the main frame to part of the rear triangle, also enables a drive unit to be mounted on the main frame.

Numerous advantages arise from combining a mounting point for a drive unit and a pivot point between the main frame and at least part of the rear triangle. In particular, the frame assembly offers a particularly space-saving and cost-effective design in the vicinity of a bottom bracket of the two-wheeled vehicle. Since the connecting element may simultaneously perform a joint function between the main frame and the rear triangle and a mounting function for the drive unit, the elimination of further mounting and/or joint elements may bring about a cost saving. Similarly, it is possible, for example, to avoid the need for drill holes in the main frame for such further mounting and/or joint elements, and this has an advantageous effect on the rigidity of the main frame. Moreover, there is more space available in the main frame for the connecting element, which may thus be positioned optimally. This results in greater design freedom, especially with regard to optimizing force transmission and kinematics. The increased space also has an advantageous impact in terms of a greater clearance for running cables and wires, from the drive unit, for example. Furthermore, for example, shorter chainstays on the rear triangle are achievable in this way, firstly to enable the ride characteristics of the two-wheeled vehicle to be influenced more selectively or more flexibly and over a broader range, and secondly to allow the geometry of the two-wheeled vehicle to be adjusted particularly flexibly, with shorter chainstays, for example, even in the case of smaller frame sizes.

Preferred developments and example embodiments of the present invention are disclosed herein.

According to an example embodiment of the present invention, the rear triangle preferably includes a suspension element, the at least one connecting element interconnecting the main frame and the suspension element so as to be pivotable about the joint axis. This means that the connecting element in this case forms a support for one side of the suspension element. The other side of the suspension element is preferably connected to other parts of the rear triangle, for example to a rocker link, which is connected to seatstays of the rear triangle. The connecting element thus allows for a pivotable connection between the suspension element and the main frame. A particularly cost-effective, simple and space-saving design of the linkage of the suspension is achievable in this way.

According to an example embodiment of the present invention, the rear triangle particularly preferably includes a rear triangle frame, the at least one connecting element interconnecting the main frame and the rear triangle frame so as to be pivotable about the joint axis. The rear triangle frame is preferably formed by chainstays and seatstays, and for example by further elements which are pivotable relative to the main frame. The connecting element preferably forms a main joint in this case, by way of which the rear triangle frame is pivotable relative to the main frame. In this way, with a cost-effective and space-saving design of the main joint, a particularly flexible kinematic design, especially in terms of ride dynamics, of the two-wheeled vehicle may be provided. Particularly preferably, two connecting elements may be provided, which connect both the suspension element and the rear triangle frame to the main frame so as to each be pivotable about a separate joint axis. Each of the two connecting elements may additionally be equipped to mount the drive unit on the main frame. In this case, the drive unit is preferably able to be mounted on the main frame exclusively by way of these two connecting elements. A particularly simple, cost-effective and space-saving design of the frame assembly may be provided in this way. Alternatively, provision may additionally also be made for a further connection point, for example, for mounting the drive unit on the main frame, by way of screws for example.

According to an example embodiment of the present invention, the frame assembly preferably further comprises a drive unit, which is mounted on the main frame by way of the at least one connecting element. The drive unit preferably comprises a motor and/or a transmission. In particular, the drive unit is fixedly connected to the main frame, such that in particular no relative rotation between the drive unit and the main frame is possible. The frame assembly particularly preferably has a total of two or three connecting elements with which the drive unit is mounted on the main frame. A particularly simple and robust assembly may be provided in this way. The drive unit preferably has a bottom bracket, such that in particular a bottom bracket axis passes through the drive unit.

The drive unit is preferably arranged at least partly between two frame walls of the main frame. For example, the drive unit may substantially be arranged completely between the two frame walls, such that the frame walls are able to offer mechanical protection for the drive unit. Alternatively, for example, only a mounting area of the drive unit may be arranged between the two frame walls, such that the drive unit is substantially arranged freely outside the main frame.

Further preferably, the connecting element includes a through-bolt, which extends along the joint axis through the main frame and the drive unit. A particularly simple and cost-effective design of the frame assembly may be provided in this way. In addition, assembly is made particularly easy, since the through-bolt may be pushed from one side into mutually aligned through-holes in the drive unit and main frame, for example, so access is required only from this one side. In this case, the through-bolt may preferably be secured by screwing on a nut on the corresponding opposite side. Particularly preferably, the drive unit is mounted on the main frame using a total of two through-bolts.

According to an example embodiment of the present invention, the connecting element preferably includes two mounting screws, each of which extends along the joint axis, and by way of which the main frame and the drive unit are screwed together. In particular, the two mounting screws are screwed into the drive unit and the main frame from opposite sides. For example, if the drive unit is arranged partly between two frame walls of the main frame, the two mounting screws may each be screwed into the drive unit through one of the frame walls in order to bring about the fixed connection between the main frame and the drive unit. The drive unit and the main frame are preferably screwed together with a total of four mounting screws or alternatively with a total of six mounting screws. Particularly preferably, it is also possible for the drive unit to be mounted using a combination of mounting screws and through-bolts.

The drive unit particularly preferably has two mounting lugs. The mounting lugs may be designed to project from a housing of the drive unit, for example. The mounting lugs are used to mount the drive unit on the main frame by way of the connecting element. A swingarm area of the rear triangle is arranged in this case between the two mounting lugs. The swingarm area is considered to be a lower and front area of the rear triangle, particularly an integral area, in which the two chainstays converge. In particular, the rear triangle is connected indirectly to the main frame via the drive unit in this case. The swingarm area and the drive unit are preferably interconnected by way of the connecting element so as to be pivotable about the joint axis.

According to an example embodiment of the present invention, the rear triangle preferably includes two chainstays, which are connected to the main frame in an articulated manner by way of the connecting element. This means that, in the vicinity of the interface between the main frame, drive unit and rear triangle, two separate chainstays are provided, each of which is connected to the main frame by way of the connecting element. For example, a single through-bolt may be provided in this case as the connecting element. Alternatively, each chainstay may be connected separately to the main frame by way of a separate mounting screw, the two mounting screws being located on the common joint axis.

Each of the two chainstays is preferably arranged between the drive unit and one of the two frame walls of the main frame with respect to a direction of the joint axis. This means that the two chainstays together with the drive unit are located at least partly within a receiving space of the main frame defined by the two frame walls.

Further preferably, according to an example embodiment of the present invention, the drive unit and the two frame walls are arranged between the two chainstays with respect to a direction of the joint axis. In other words, the two chainstays are arranged outside the main frame with respect to the direction of the joint axis.

The connecting element preferably includes at least one bearing, in particular a ball bearing or a plain bearing, which is arranged between the main frame and at least part of the rear triangle. The connecting element preferably includes at least two bearings in order to obtain a stable mechanical support. In particular, a bearing is arranged between each of the two frame walls and each chainstay or the swingarm area, respectively.

The present invention moreover includes a two-wheeled vehicle which comprises the frame assembly as disclosed herein. The two-wheeled vehicle is preferably a bicycle which is operable with muscle power and/or motor power, particularly preferably an electric bicycle. In particular, it is a full-suspension electric bicycle. Owing to the specific frame assembly with the connecting element which acts as a main joint and also forms a mounting interface for the drive unit, a particularly space-saving arrangement of the various components may be achieved in the vicinity of the bottom bracket axis. In particular, the electric bicycle geometry may be designed with regard to optimizing kinematics and ride dynamics. Particularly preferably, the frame assembly may be designed in such a way that the connecting element is arranged at the level of a chain mesh point between a bicycle chain and a chainring arranged on the bottom bracket. In this case, the joint axis is preferably located at or near the chain mesh point. The chain mesh point is regarded as the point at which the manual driving force of the rider is applied by the chainring to the bicycle chain.

According to an example embodiment of the present invention, the frame assembly preferably comprises a drive unit, which is mounted on the main frame by way of at least one connecting element. The at least one connecting element is arranged in a rear area in the direction of travel, preferably at a rear end in the direction of travel, of the drive unit. This means that the drive unit extends substantially forwards in the direction of travel from the connecting element. A particularly space-saving arrangement may be provided in this way, to allow for an optimal arrangement of a suspension system and for an optimal adjustment of the geometry of the frame assembly in terms of kinematics and ride dynamics.

### BRIEF DESCRIPTION OF THE DRAWINGS

The present invention is described below by reference to exemplary embodiments in connection with the figures. In the figures, functionally identical components are identified by the same reference signs.

FIG. 1 shows a simplified schematic view of a two-wheeled vehicle according to a first exemplary embodiment of the present invention.

FIG. 2 shows a detail of the two-wheeled vehicle from FIG. 1.

FIG. 3 shows a detail of a two-wheeled vehicle according to a second exemplary embodiment of the present invention.

FIG. 4 shows a detail of a two-wheeled vehicle according to a third exemplary embodiment of the present invention.

FIG. 5 shows a detail of a two-wheeled vehicle according to a fourth exemplary embodiment of the present invention.

FIG. 6 shows a detail of a two-wheeled vehicle according to a fifth exemplary embodiment of the present invention.

FIG. 7 shows a simplified schematic view of a two-wheeled vehicle according to a fifth exemplary embodiment of the present invention.

### DETAILED DESCRIPTION OF EXAMPLE EMBODIMENTS

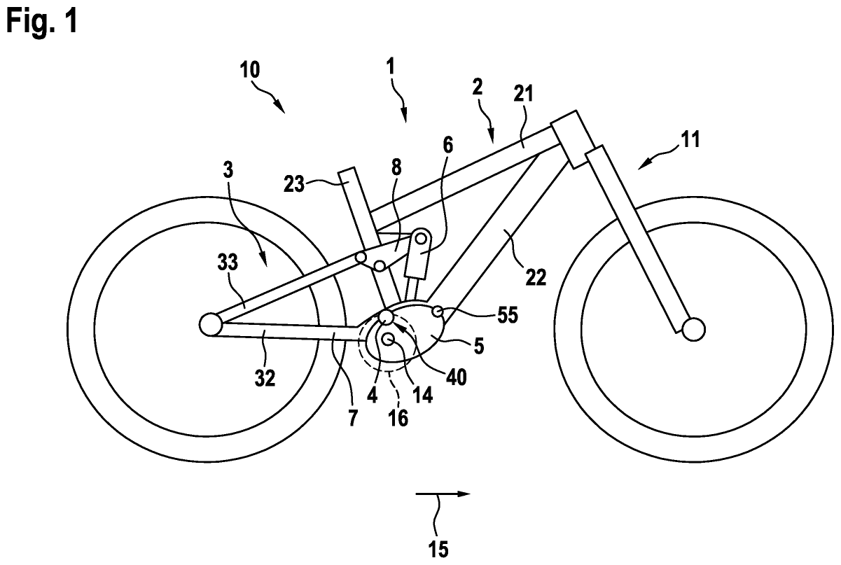

FIG. 1 shows a simplified schematic view of a two-wheeled vehicle 10 according to a first exemplary embodiment of the present invention. Two-wheeled vehicle 10 is an electric bicycle which is operable with muscle power and/or motor power.

Two-wheeled vehicle 10 has a frame assembly 1 with a drive unit 5, which comprises an electric motor and a transmission and which is designed to support a pedaling power of a rider with motor power. To supply drive unit 5 with energy, two-wheeled vehicle 10 may include a rechargeable battery (not shown).

A bottom bracket 14 of two-wheeled vehicle 10 is part of drive unit 5. Bottom bracket 14 is provided for connection to cranks and pedals (not shown).

Two-wheeled vehicle 10 is a full-suspension two-wheeled vehicle with a suspension fork 11 and a sprung rear triangle 3.

Sprung rear triangle 3 has a rear triangle frame 7, which is connected to a main frame 2 of frame assembly 1 of two-wheeled vehicle 10 so as to be pivotable about a joint axis 40. Joint axis 40 is in this case perpendicular to the drawing plane of FIG. 1.

In particular, rear triangle frame 7 comprises chainstays 32 and seatstays 33, which are arranged at an acute angle to one another. Main frame 2 preferably includes a top tube 21, a down tube 22, and a seat post 23, which in particular are likewise arranged substantially in a triangular form.

Rear triangle 3 additionally includes a suspension element 6 and a rocker link 8. Suspension element 6 is connected in an articulated manner to rocker link 8 and to main frame 2. In addition, rocker link 8 is connected in an articulated manner to an upper end of rear triangle frame 7, in this detail to seatstay 33. Rocker link 8 is also connected in an articulated manner to seat post 23.

To permit the pivotable connection of main frame 2 and rear triangle frame 7, frame assembly 1 comprises a connecting element 4, which is arranged on main frame 2. Connecting element 4 may thus also be regarded as a main joint of the suspension of two-wheeled vehicle 10. Connecting element 4 is additionally equipped for mounting drive unit 5 on main frame 2. Connecting element 4 thus fulfils the two functions of interconnecting rear triangle frame 7 and main frame 2 in an articulated manner and at the same time mounting drive unit 5 on main frame 2.

Connecting element 4 forms a connection point here between drive unit 5 and the main frame, arranged in a rear area of drive unit in the direction of travel 15 of two-wheeled vehicle 10.

Unifying the mounting point and pivot point in this way offers numerous advantages. It allows in particular for an especially space-saving design of frame assembly 1 in the vicinity of drive unit 5. In particular, the kinematics of the two-wheeled vehicle may be optimized in terms of ride dynamics in this way, since connecting element 4 and hence also joint axis 40 may be arranged particularly close to the axis of bottom bracket 14. Joint axis 40 is preferably located in this case at a chain mesh point between a bicycle chain and a chainring 16 of two-wheeled vehicle 10. The chain mesh point is located vertically above bottom bracket 14 and on or near the outer circumference of chainring 16. In addition, unifying the main pivot point of frame assembly 1 and the mounting point of drive unit 5 permits weight and cost savings, since there is no need for mounting means, for example.

In the first exemplary embodiment of FIG. 1, drive unit 5 is fixedly connected to main frame 2 at a total of two mounting points. The first mounting point is formed by connecting element 4 and the second mounting point by a mounting means 55 at the front area of drive unit 5 in direction of travel 15. The second mounting means may be, for example, a screw connection with a through-bolt and/or with one or more screws.

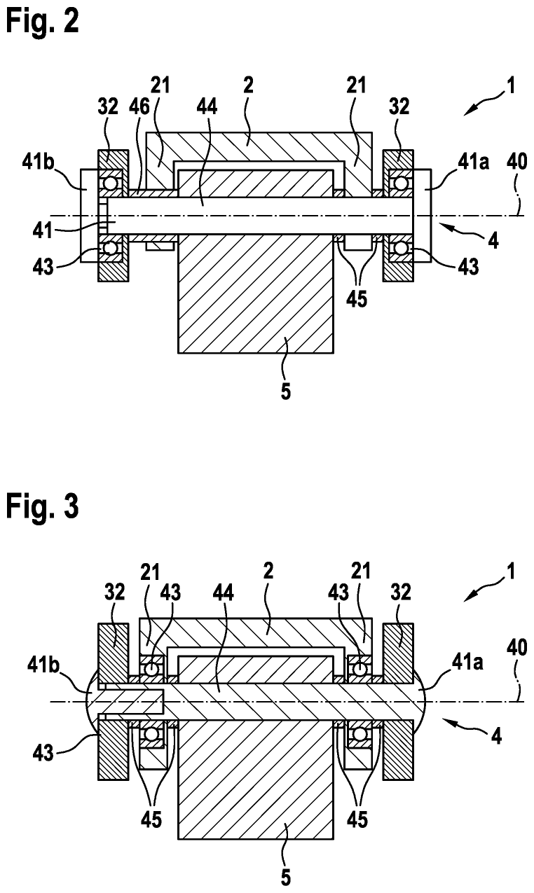

The more precise embodiment of the connection between main frame 2, rear triangle frame 7 and drive unit 5 by way of connecting element 4 is described in detail below by reference to FIG. 2. FIG. 2 shows a detailed sectional view of two-wheeled vehicle from FIG. 1 in the vicinity of connecting element 4.

As is clear from FIG. 2, drive unit 5 is arranged partly inside main frame 2, in this detail between two frame walls 21 of main frame 2. The two chainstays 32 of rear triangle 3 are arranged outside main frame 2, relative to joint axis 40.

Connecting element 4 includes a through-bolt 41, which extends along joint axis 40 through main frame 2, drive unit 5 and the two chainstays 32. Through-bolt 41 offers a particularly simple, cost-effective and at the same time stable connection of drive unit 5 and main frame 2.

Through-bolt 41 has a bolt head 41a, which may bear against right-hand chainstay 32 in FIG. 2. In addition, through-bolt 41 has a nut 41b, which on the opposite side may bear against left-hand chainstay 32 and which may be screwed on to a bolt area 44 of through-bolt 41 in order to secure through-bolt 41.

To permit the pivotable connection of main frame 2 and rear triangle 3 about joint axis 40, a bearing 43 is arranged between each of chainstays 32 of rear triangle 3 and through-bolt 41. Bearings 43 are shown by way of example as ball bearings. Bearings 43 could also alternatively be in the form of plain bearings or the like.

Furthermore, frame assembly 1 includes spacer sleeves 45 and a tolerance compensation element 46 in the vicinity of connecting element 4. Spacer sleeves 45 are arranged, respectively, between right-hand chainstay 32 and right-hand frame wall 21 and between right-hand frame wall 21 and drive unit 5. Tolerance compensation element 46 is designed in the form of a sleeve which is arranged on an outer side of bolt area 44 of through-bolt 41 and between bolt area 44 and left-hand frame wall 21. Moreover, tolerance compensation element 46 is arranged between drive unit 5 and left-hand chainstay 32. Spacer sleeves 45 and tolerance compensation element 46 facilitate an optimal geometric adjustment of frame assembly 1, in a particularly simple and cost-effective manner.

FIG. 3 shows a detail of a sectional view, similar to FIG. 2, of a two-wheeled vehicle 10 according to a second exemplary embodiment of the present invention. The second exemplary embodiment corresponds substantially to the first exemplary embodiment of FIGS. 1 and 2, the only difference being an alternative arrangement of bearings 43. In the second exemplary embodiment of FIG. 3, bearings 43 are arranged between bolt area 44 of through-bolt 41 and frame walls 21. An alternative, advantageous design and kinematics of frame assembly 1 may be provided in this way.

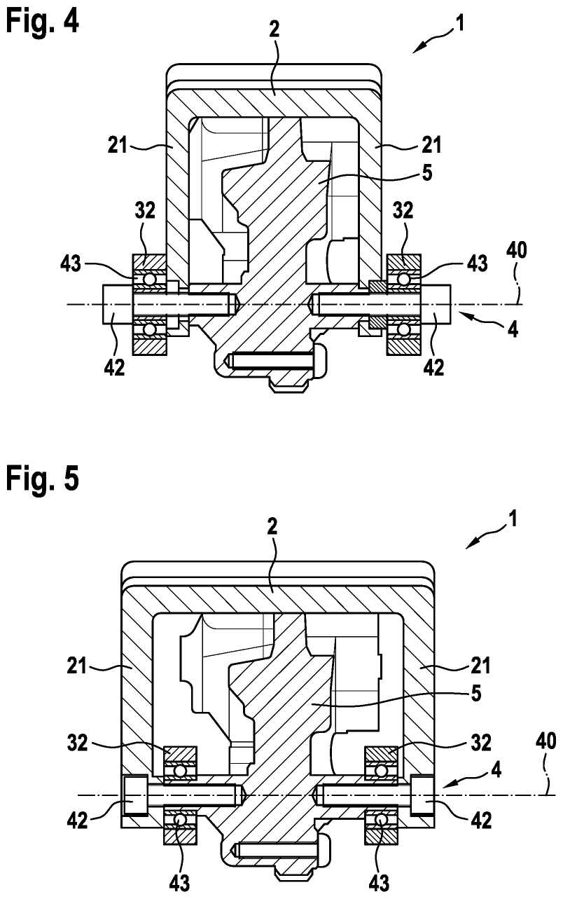

FIG. 4 shows a detail of a sectional view, similar to FIG. 2, of a two-wheeled vehicle 10 according to a third exemplary embodiment of the present invention. The third exemplary embodiment corresponds substantially to the first exemplary embodiment of FIGS. 1 and 2, the only difference being that connecting element 4 has two mounting screws 42 instead of a through-bolt 41. The two mounting screws 42 are each screwed into the assembly comprising chainstay 32, frame wall 21 and drive unit 5 from outside, along joint axis 40. The two mounting screws 42 are screwed tightly into drive unit 5. Between each mounting screw 42 and the corresponding chainstay 32 there is a bearing 43.

Furthermore, no spacer sleeve and no tolerance compensation element is provided in the third exemplary embodiment. Instead, the elements are screwed directly to one another, in particular such that, when assembled by way of mounting screws 42, chainstays 32 are drawn towards main frame 2, placing drive unit under tension. Alternatively, however, provision could also be made for a spacer sleeve and a tolerance compensation element, as in FIG. 2. Connecting element 4 with the two mounting screws 42 according to the third exemplary embodiment of FIG. 4 offers a further particularly cost-effective, simple and space-saving connection option.

FIG. 5 shows a detail of a sectional view, similar to FIGS. 2 through 4, of a two-wheeled vehicle 10 according to a fourth exemplary embodiment of the present invention. The fourth exemplary embodiment corresponds substantially to the first exemplary embodiment of FIGS. 1 and 2, the only difference being that chainstays 32 are arranged inside main frame 2. In this detail, the two chainstays 32 are each arranged between drive unit 5 and one of frame walls 21. Similarly to the third exemplary embodiment of FIG. 4, connecting element 4 in the fourth exemplary embodiment has two mounting screws 42, which are screwed into drive unit 5. Likewise, there is preferably no tolerance compensation by way of a spacer sleeve and/or tolerance compensation element in the fourth exemplary embodiment, as shown in FIG. 5. In an alternative embodiment, however, the two-wheeled vehicle of the fourth exemplary embodiment could also be equipped with a spacer sleeve and/or a tolerance compensation element.

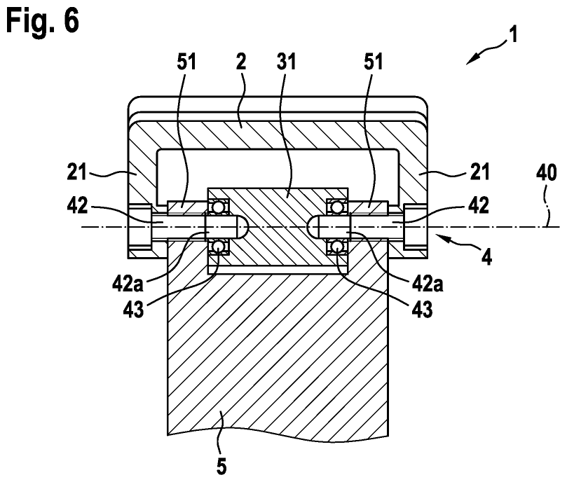

FIG. 6 shows a detail of a sectional view of a two-wheeled vehicle 10 according to a fifth exemplary embodiment of the present invention. The fifth exemplary embodiment corresponds substantially to the first exemplary embodiment of FIGS. 1 and 2, with a further alternative arrangement of frame walls 21, drive unit 5 and rear triangle 3. In the fifth exemplary embodiment of FIG. 6, drive unit 5 comprises two mounting lugs 51, with which drive unit 5 is mounted on main frame 2 by way of connecting element 4. In this detail, mounting lugs 51 project into a receiving space between the two frame walls 21, the rest of drive unit 5 being arranged outside. Each mounting lug 51 is screwed to the corresponding frame wall 21 by way of a mounting screw 42.

A swingarm area 31 of rear triangle 3 is arranged between the two mounting lugs 51. Swingarm area 31 corresponds here to an integral area located at the front end of rear triangle frame 7 in direction of travel 15 (see FIG. 1), to which the two chainstays 32 converge. The pivotable mounting of swingarm area 31 on main frame 2 is effected indirectly here via drive unit 5. To this end, the two mounting screws 42 each have a preferably threadless connecting area 42a, which extends into swingarm area 31. A bearing 43 is positioned between each connecting area 42a and swingarm area 31.

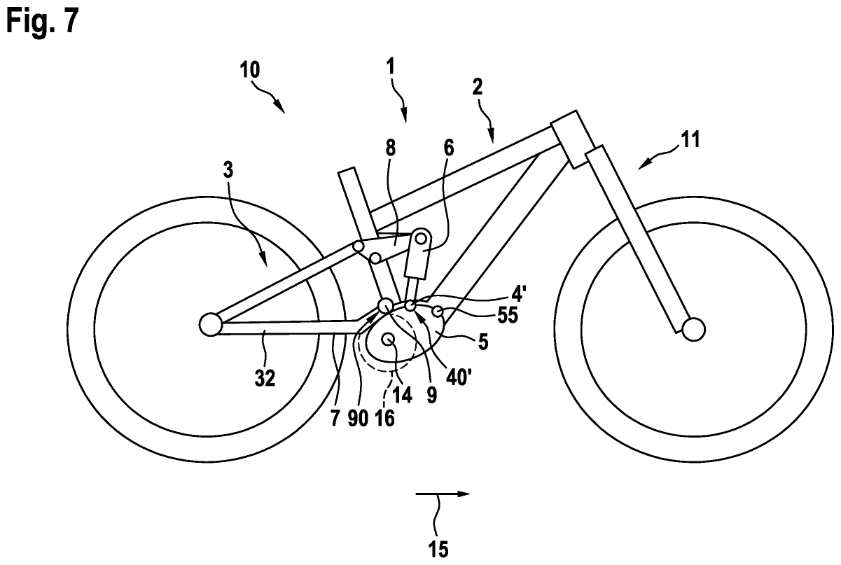

FIG. 7 shows a simplified schematic view of a two-wheeled vehicle 10 according to a sixth exemplary embodiment of the present invention. The sixth exemplary embodiment corresponds substantially to the first exemplary embodiment of FIGS. 1 and 2, connecting element 4′ rather than rear triangle frame 7 interconnecting suspension element 6 and main frame 2 so as to be pivotable about another joint axis 40′. As in the first exemplary embodiment of FIG. 1, connecting element 4′ acts both as a joint, for the articulated connection of suspension element 6 and main frame 2, and as a mounting means, for mounting drive unit 5 on main frame 2.

In total, two-wheeled vehicle 10 of the sixth exemplary embodiment has two mounting points for drive unit 5, specifically connecting element 4′ and mounting means 55 between main frame 2 and the front area of drive unit 5. In the case of two-wheeled vehicle 10 shown in FIG. 7, the joint identified by reference sign 9 serves only to provide the articulated connection between rear triangle frame 7 and main frame 2 about main joint axis 90.

Connecting element 4′ may preferably be designed according to either of the variants described, in other words with a through-bolt or alternatively with two mounting screws. Drive unit 5 may preferably also be mounted using a combination of through-bolt and mounting screws.

It should further be noted that the aforementioned exemplary embodiments may also be combined with one another in any way. Particularly preferably, the first and the sixth exemplary embodiments may be combined in such a way that a connecting element is used both at the main joint between rear triangle frame 7 and main frame 2 and between suspension element 6 and main frame 2, allowing for an articulated connection and at the same time mounting drive unit 5. In particular, just these two mounting points may be provided for mounting drive unit 5 on main frame 2, or, alternatively, provision may be made for mounting at a total of three mounting points, by way of the mounting means 55 additionally shown in FIGS. 1 and 7, for example.

1-14. (canceled)

15. A frame assembly of a two-wheeled vehicle, the two-wheeled vehicle being operable with muscle power and/or motor power, the frame assembly comprising:
a main frame;
a sprung rear triangle; and
at least one connecting element arranged on the main frame, wherein the connecting element connects at least a part of the rear triangle to the main frame so as to be pivotable about a joint axis, and the at least one connecting element is configured for mounting a drive unit on the main frame.

16. The frame assembly as recited in claim 15, wherein the rear triangle includes a suspension element, the at least one connecting element pivotably interconnecting the main frame and the suspension element.

17. The frame assembly as recited in claim 15, wherein the rear triangle includes a rear triangle frame, the at least one connecting element pivotably interconnecting the main frame and the rear triangle frame.

18. The frame assembly as recited in claim 15, further comprising:
a drive unit mounted on the main frame using the at least one connecting element, the drive unit including a motor and/or a transmission.

19. The frame assembly as recited in claim 18, wherein the drive unit is arranged at least partly between two frame walls of the main frame.

20. The frame assembly as recited in claim 18, wherein the at least one connecting element includes a through-bolt, which extends along the joint axis through the main frame and the drive unit.

21. The frame assembly as recited in claim 18, wherein the at least one connecting element includes two mounting screws, which each extend along the joint axis and with which the main frame and the drive unit are screwed together.

22. The frame assembly as recited in claim 18, wherein the drive unit includes two mounting lugs, with which the drive unit is mounted on the main frame using the at least one connecting element, a swingarm area of the rear triangle being arranged between the two mounting lugs.

23. The frame assembly as recited in claim 15, wherein the rear triangle includes two chainstays which are connected to the main frame in an articulated manner using the at least one connecting element.

24. The frame assembly as recited in claim 23, wherein each of the two chainstays is arranged between the drive unit and one of two frame walls of the main frame with respect to the joint axis.

25. The frame assembly as recited in claim 23, wherein the drive unit and two frame walls of the main frame are arranged between the two chainstays with respect to the joint axis.

26. The frame assembly as recited in claim 15, wherein the at least one connecting element includes at least one bearing, which is arranged between the main frame and at least part of the rear triangle.

27. A two-wheeled vehicle including a bicycle operable with muscle power and/or motor power, the two-wheeled vehicle comprising:
a frame assembly including:
a main frame,
a sprung rear triangle, and
at least one connecting element arranged on the main frame, wherein the connecting element connects at least a part of the rear triangle to the main frame so as to be pivotable about a joint axis, and the at least one connecting element is configured for mounting a drive unit on the main frame.

28. The two-wheeled vehicle as recited in claim 27, wherein the frame assembly further includes a drive unit, the drive unit being mounted on the main frame using the at least one connecting element, and the at least one connecting element being arranged on a rear area of the drive unit in a direction of travel.
